(19) United States
(12) Patent Application Publication
(10) Pub. No.: US 2026/0267057 A1
(43) Pub. Date: Sep. 10, 2026

(54) OPTICAL MODULE AND AN ELECTRONIC DEVICE

(71) Applicant: LITE-ON TECHNOLOGY CORPORATION, TAIPEI CITY (TW)

(72) Inventors: PO-WEI CHEN, New Taipei City (TW); CHIN-KUAN LIN, NEW TAIPEI CITY (TW); SHIH-YUAN KUO, NEW TAIPEI CITY (TW); JU-LING CHENG, New Taipei City (TW); CHAO-MING WU, YILAN COUNTY (TW)

(21) Appl. No.: 19/414,173

(22) Filed: Dec. 9, 2025

Related U.S. Application Data
(60) Provisional application No. 63/768,179, filed on Mar. 7, 2025.

(30) Foreign Application Priority Data
Aug. 19, 2025 (CN) 202521762330.4

(51) Int. Cl. F21V 8/00

(52) U.S. Cl. CPC G02B 6/0068; G02B 6/0035; G02B 6/0055; G02B 6/0076; G02B 6/0088

(57) ABSTRACT

An optical module and an electronic device are disclosed. The module includes a substrate, light guide plate, first and second light-emitting elements, a reflective layer, light-transmissive layer, and first and second pattern layers. The light-emitting elements are arranged on the substrate, with the reflective layer positioned between the substrate and the light guide plate. The light guide plate has first and second side portions that are opposite to each other and that respectively face the first and second light-emitting elements. The first and second pattern layers are formed on different portions of the light guide plate surface, and the light-transmissive layer covers the light guide plate.

### CROSS-REFERENCE TO RELATED PATENT APPLICATION

This application claims the benefit of priority to U.S. Provisional Patent Application No. 63/768,179, filed on Mar. 7, 2025, and Chinese Patent Application No. 202521762330.4, filed on Aug. 19, 2025. The entire contents of the above-identified applications are incorporated herein by reference.

Some references, which may include patents, patent applications, and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entirety and to the same extent as if each reference were individually incorporated by reference.

### FIELD OF THE DISCLOSURE

The present disclosure relates to an optical module, and more particularly to an optical module and an electronic device capable of selectively presenting two different light-emitting visual effects.

### BACKGROUND OF THE DISCLOSURE

With the popularization of electronic devices and the advancement of technology, consumers’ demand for the aesthetic appearance of housing of electronic devices has been increasing. Existing housing for electronic devices provides limited visual effects due to their singular color and pattern presentation. Accordingly, improving visual effects through structural and design modifications has become one of the important issues to be addressed in the relevant industry.

### SUMMARY OF THE DISCLOSURE

In order to solve the above-mentioned technical problem, one of the technical aspects adopted by the present disclosure is to provide an optical module. The optical module includes: a substrate, a light guide plate, at least one first light-emitting element, a reflective layer, at least one second light-emitting element, a light-transmissive layer, a first pattern layer, and a second pattern layer.

The light guide plate is disposed above the substrate and has a first surface and a second surface opposite to the first surface, the second surface facing the substrate. The light guide plate extends in a first direction and has a first side portion and a second side portion opposite to the first side portion. The second surface is divided into at least two regions, one of the regions of the second surface adjacent to the first side portion being defined as a first region, and another region of the second surface adjacent to the second side portion being defined as a second region. At least one first light-emitting element is disposed on the substrate and configured to emit light toward the first side portion of the light guide plate. A reflective layer is disposed between the substrate and the light guide plate and corresponds to the first region. At least one second light-emitting element is disposed on the substrate opposite to the at least one first light-emitting element and configured to emit light toward the second side portion of the light guide plate. A light-transmissive layer is disposed above the light guide plate and away from the substrate. A first pattern layer corresponding to the first region is formed on any surface of the light guide plate. A second pattern layer corresponding to the second region is formed on any surface of the light guide plate, or on a surface of the light-transmissive layer. The at least one first light-emitting element and the at least one second light-emitting element are controllable to be selectively turned on or off.

In one possible embodiment, the reflective layer further extends along the first direction and corresponds to the second region.

In one possible embodiment, the optical module further includes a covering layer corresponding to the second region and disposed between the reflective layer and the light guide plate.

In one possible embodiment, the optical module further includes a covering layer corresponding to the second region and disposed between the substrate and the light guide plate.

In one possible embodiment, the optical module further includes a barrier layer formed between the first side portion and the second side portion, the barrier being configured to separate the light-transmissive layer from the light guide plate and to divide the first region and the second region.

In one possible embodiment, the barrier layer is made of an opaque material.

In one possible embodiment, the barrier layer is an air layer.

In one possible embodiment, the at least one first light-emitting element comprises a plurality of first light-emitting elements arranged at intervals along a second direction, with a first interval defined between two adjacent first light-emitting elements; and the at least one second light-emitting element comprises a plurality of second light-emitting elements arranged at intervals along the second direction, with a second interval defined between two adjacent second light-emitting elements.

In one possible embodiment, an orthogonal projection of the first pattern layer onto the substrate does not overlap or partially overlaps an orthogonal projection of the second pattern layer onto the substrate.

In one possible embodiment, the optical module further includes a supporting frame and a light-transmissive cover. The supporting frame is disposed between the light-transmissive layer and the light guide plate. The light-transmissive cover is disposed on and is tightly bonded to the light-transmissive layer.

In one possible embodiment, the light-transmissive layer is a semi-transmissive film, and the reflectance of the light-transmissive layer is greater than or equal to the transmittance of the light-transmissive layer.

In one possible embodiment, the light-transmissive layer is a semi-transmissive film, or is formed by splicing a fully-transmissive film and the semi-transmissive film along the first direction.

In one possible embodiment, the at least one first light-emitting element emits light to present a first visual effect through the first pattern layer, and the at least one second light-emitting element emits light to present a second visual effect through the second pattern layer, the first visual effect and the second visual effect being displayed simultaneously or individually.

In one possible embodiment, the first visual effect is an infinity mirror effect, and the second visual effect is a normal display effect.

In order to solve the above-mentioned technical problem, another technical aspect adopted by the present disclosure is to provide an optical module. The optical module includes: a substrate, a reflective layer, a first light guide plate, a first pattern layer, at least one first light-emitting element, a supporting frame, a first light-transmissive layer, at least one second light-emitting element, a second light guide plate, a second pattern layer, and a second light-transmissive layer.

The reflective layer is disposed on the substrate. The first light guide plate is disposed on the reflective layer and has a first surface and a second surface opposite to the first surface, the second surface facing the substrate. The first light guide plate extends in a first direction and defines a first side portion and an opposite second side portion. The first pattern layer is formed on the first surface or the second surface of the first light guide plate. At least one first light-emitting element is disposed on the substrate and configured to emit light toward the first side portion of the first light guide plate. A supporting frame is disposed above the first light guide plate. A first light-transmissive layer is disposed on the supporting frame and away from the substrate. At least one second light-emitting element is disposed on the substrate. A second light guide plate is disposed on the first light-transmissive layer and has a third surface and a fourth surface opposite to the third surface, the fourth surface facing the substrate. The second light guide plate extends in the first direction and defines a third side portion and an opposite fourth side portion, wherein the fourth side portion is adjacent to a light-emitting surface of the at least one second light-emitting element. The second pattern layer is formed on the third surface or the fourth surface of the second light guide plate. A second light-transmissive layer is disposed on the second light guide plate. The at least one first light-emitting element and the at least one second light-emitting element are controllable to be selectively turned on or off.

In one possible embodiment, the substrate includes a main body part and an extension part, the extension part being disposed on the main body part and adjacent to the second side portion of the first light guide plate. The at least one second light-emitting element is disposed on the extension part and configured to emit light toward the fourth side portion of the second light guide plate. The reflective layer is disposed on the main body part. The second surface of the first light guide plate faces the main body part. The at least one first light-emitting element is disposed on the main body part and configured to emit light toward the first side portion of the first light guide plate. The fourth surface of the second light guide plate faces the main body part.

In one possible embodiment, the second light guide plate is flexible and comprises a bent portion and an extension portion. One end of the bent portion is connected to the extension portion, while the other end of the bent portion is adjacent to the light-emitting surface of the second light-emitting element. The extension portion covers the first light-transmissive layer. The second light-transmissive layer covers the extension portion.

In one possible embodiment, the at least one second light-emitting element has a light-emitting direction orthogonal to the light-emitting surface and forms an included angle with a surface of the substrate.

In one possible embodiment, the at least one first light-emitting element comprises a plurality of first light-emitting elements arranged at intervals along a second direction, with a first interval defined between two adjacent first light-emitting elements; and the at least one second light-emitting element comprises a plurality of second light-emitting elements arranged at intervals along the second direction, with a second interval defined between two adjacent second light-emitting elements.

In one possible embodiment, an orthogonal projection of the first pattern layer onto the substrate does not overlap or partially overlaps an orthogonal projection of the second pattern layer onto the substrate.

In one possible embodiment, the first light-transmissive layer is a semi-transmissive film, and the reflectance of the light-transmissive layer is greater than or equal to the transmittance of the light-transmissive layer.

In one possible embodiment, the optical module further includes a light-transmissive cover. The light-transmissive cover is disposed on and is tightly bonded to the second light-transmissive layer.

In one possible embodiment, the at least one first light-emitting element emits light to present a first visual effect through the first pattern layer, and the at least one second light-emitting element emits light to present a second visual effect through the second pattern layer, the first visual effect and the second visual effect being displayed simultaneously or individually.

In one possible embodiment, the first visual effect is an infinity mirror effect, and the second visual effect is a normal display effect.

In order to solve the above-mentioned technical problem, yet another technical aspect adopted by the present disclosure is to provide an electronic device. The electronic device includes: a housing and the optical module, wherein the optical module is disposed within the housing.

In one possible embodiment, the at least one first light-emitting element emits light to present a first visual effect through the first pattern layer, and the at least one second light-emitting element emits light to present a second visual effect through the second pattern layer, the first visual effect and the second visual effect being displayed simultaneously or individually.

In one possible embodiment, the first visual effect is an infinity mirror effect, and the second visual effect is a normal display effect.

One of the technical advantages of the present disclosure is that, by virtue of “the first pattern layer corresponding to the first region formed on any surface of the light guide plate,” “the second pattern layer corresponding to the second region formed on any surface of the light guide plate or on a surface of the light-transmissive layer,” and “the first light-emitting element and the second light-emitting element being controllable to selectively turn on or off,” the visual effect of the optical module is improved, wherein the first visual effect presented by the first pattern layer is different from the second visual effect presented by the second pattern layer. For example, the light emission of the first pattern layer provides an infinity mirror visual effect (first visual effect), while the light emission of the second pattern layer provides a normal display effect (second visual effect). The light emission effects of the first pattern layer and the second pattern layer can be displayed simultaneously or individually.

Another technical advantage of the present disclosure is that, by incorporating the optical module into an electronic device, the electronic device is provided with both the first visual effect and the second visual effect, which can be selectively displayed simultaneously or individually. Accordingly, the housing of the electronic device can present more diverse in terms of colors or patterns.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic cross-sectional view of an optical module according to one embodiment of the present disclosure;

FIG. 2 is a schematic cross-sectional view of the optical module according to one embodiment of the present disclosure;

FIG. 3 is a schematic cross-sectional view of the optical module according to one embodiment of the present disclosure;

FIG. 4 is a schematic cross-sectional view of the optical module according to one embodiment of the present disclosure;

FIG. 5 is a schematic partial top view of the optical module according to one embodiment of the present disclosure;

FIG. 6 is a schematic cross-sectional view of the optical module according to one embodiment of the present disclosure;

FIG. 7 is a schematic cross-sectional view of the optical module according to one embodiment of the present disclosure;

FIG. 8 is a schematic cross-sectional view of the optical module according to one embodiment of the present disclosure; and

FIG. 9 is a schematic top perspective view of an electronic device according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification, including examples of any terms, is illustrative only and in no way limits the scope and meaning of the present disclosure or of any exemplified term. Likewise, the present disclosure is not limited to the various embodiments given herein. Numbering terms such as “first,” “second,” or “third” can be used to describe various components, signals, or the like, which are for distinguishing one component/signal from another one only, and are not intended to, nor should be construed to impose any substantive limitations on the components, signals, or the like.

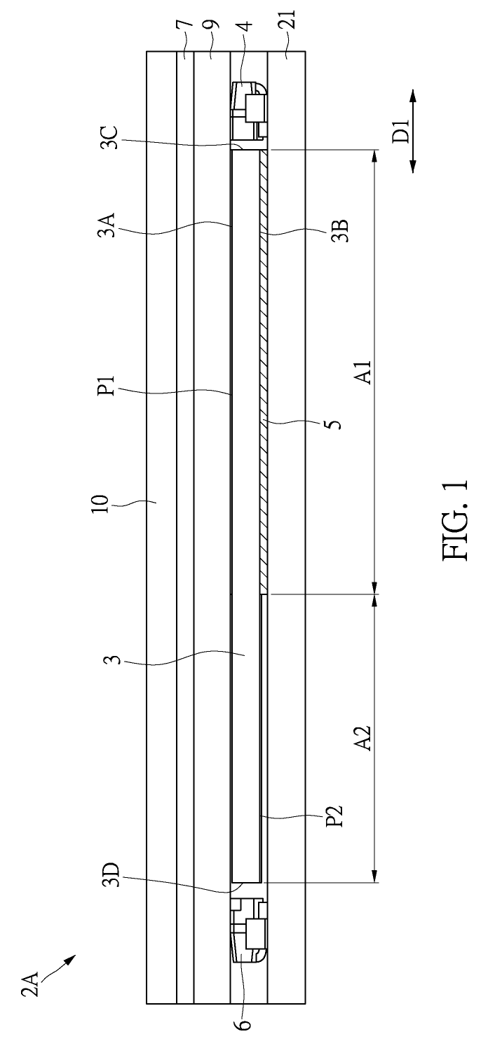

Reference is made to FIG. 1, which is a schematic cross-sectional view of an optical module 2A according to one embodiment of the present disclosure. The optical module includes: a substrate 21, a light guide plate 3, a first light-emitting element 4, a reflective layer 5, a second light-emitting element 6, a light-transmissive layer 7, a first pattern layer P1, and a second pattern layer P2.

The substrate 21 is in a plate-like structure and may include conductive circuits, such as a printed circuit board. The material composition of the printed circuit board is a known technology in the art and thus is not described herein. In other embodiments, the substrate 21 may also be a flexible printed circuit board (FPCB), allowing the optical module of the present disclosure to be applied to bendable designs. The light guide plate 3 is disposed above the substrate 21 and has a first surface 3A and a second surface 3B opposite the first surface 3A, the second surface 3B facing the substrate 21. The light guide plate 3 extends in a first direction D1, and has a first side portion 3C and a second side portion 3D opposite to the first side portion 3C. The second surface 3B of the light guide plate 3 may be divided into at least two regions. A region of the second surface 3B adjacent to the first side portion 3C is defined as a first region A1, and a region adjacent to the second side portion 3D is defined as a second region A2.

The first light-emitting element 4 may be, for example, but not limited to, a light-emitting diode (LED). The number of first light-emitting elements 4 may be one or more, including LED light sources of N different colors. The first light-emitting element 4 is disposed on the substrate 21 and emits light toward the first side portion 3C of the light guide plate 3. As shown in FIG. 1, the second light-emitting element 6 is disposed on the substrate 21 opposite to the first light-emitting element 4. The second light-emitting element 6 may also be, but is not limited to, a light-emitting diode (LED). The number of the second light-emitting element 6 may likewise be one or more, including LED light sources of N different colors. The second light-emitting element 6 emits light toward the second side portion 3D of the light guide plate 3. The type, structure, size, emission wavelength, color, and quantity of the first light-emitting element 4 and the second light-emitting element 6 may be the same or different. Furthermore, the positional arrangement of the first light-emitting element 4 and the second light-emitting element 6 may be determined according to design requirements and is not limited to the above embodiment.

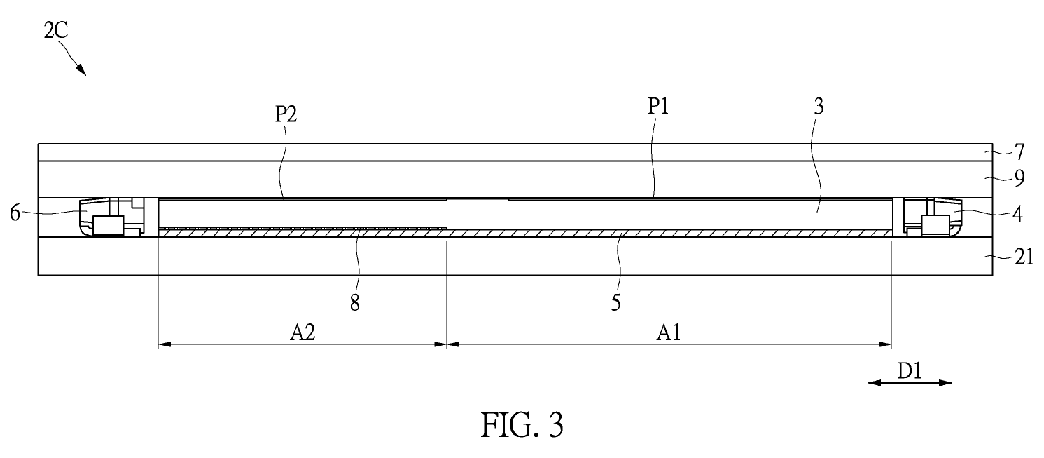

The reflective layer 5 is disposed between the substrate 21 and the light guide plate 3 and corresponds to the first region A1. In one embodiment, a vertical projection area of the reflective layer 5 onto the substrate 21 may be less than or equal to the vertical projection area of the first region A1 onto the substrate 21, but the present disclosure is not limited thereto. In another embodiment, the vertical projection area of the reflective layer 5 onto the substrate 21 may be greater than the vertical projection area of the first region A1 onto the substrate 21 (see FIG. 3).

The light-transmissive layer 7 is disposed above the light guide plate 3 and arranged away from the substrate 21. In some embodiments, the light-transmissive layer 7 is a semi-transmissive film, meaning that a portion of light can pass through while another portion of light is reflected. In some embodiments, the reflectance of the light-transmissive layer 7 may be greater than or equal to a transmittance of the light-transmissive layer 7, for example, the reflectance may be 82% and the transmittance 18%. In some embodiments, the light-transmissive layer 7 may also be formed by splicing a semi-transmissive film and a fully-transmissive film along the first direction D1, corresponding to the first region A1 and the second region A2, respectively, and is not limited in the present disclosure.

The first pattern layer P1 corresponding to the first region A1 is formed on any surface of the light guide plate 3, which may be the upper surface or the lower surface. The second pattern layer P2 corresponding to the second region A2 is formed on any surface of the light guide plate 3, which may also be the upper surface or the lower surface. In other embodiments, the second pattern layer P2 may alternatively be formed on a surface of the light-transmissive layer 7, without limitation to the present disclosure. The preset patterns of the first pattern layer P1 and the second pattern layer P2 may be identical or different. The first pattern layer P1 may be formed on the light guide plate 3 by spraying or printing. Similarly, the second pattern layer P2 may be formed on the light guide plate 3 or on the light-transmissive layer 7 by spraying or printing. In some embodiments, the vertical projection areas of the first pattern layer P1 and the second pattern layer P2 onto the substrate 21 are non-overlapping or partially overlapping.

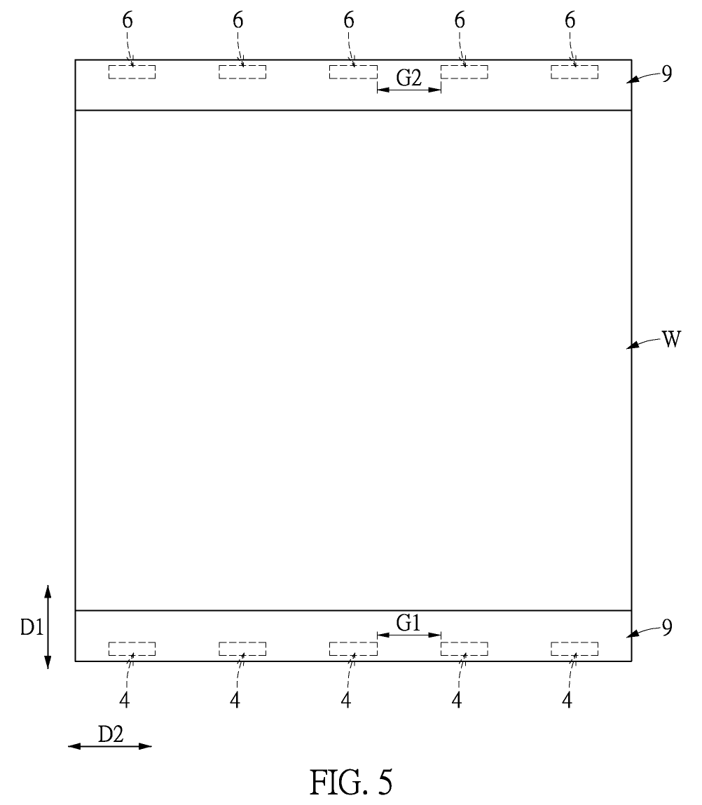

Reference is further made to FIG. 1. In this embodiment, the first pattern layer P1 and the second pattern layer P2 are both formed on any surface of the light guide plate 3. The optical module 2A further comprises a supporting frame 9. The supporting frame 9 is disposed between the light-transmissive layer 7 and the light guide plate 3, and has a predetermined height. The supporting frame 9 is in a hollowed-out shape and has a display window W (see FIG. 5). The first light-emitting element 4 and the second light-emitting element 6 are controllable to be selectively turned on or off. In other words, the first light-emitting element 4 and the second light-emitting element 6 may emit light simultaneously or not simultaneously; alternatively, only the first light-emitting element 4 or the second light-emitting element 6 may be selectively turned on. Regarding the first light-emitting element 4 and the first pattern layer P1, when the first light-emitting element 4 is turned on, a first visual effect, for example, an infinity mirror effect, can be displayed. Regarding the second light-emitting element 6 and the second pattern layer P2, when the second light-emitting element 6 is turned on, a second visual effect can be displayed, for example, a normal display effect, such as a static pattern. Based on this structural design, by selectively controlling the switching of the first light-emitting element 4 and the second light-emitting element 6, various patterns and color variations can be generated, allowing a user to view either separately or simultaneously the first visual effect produced by the first pattern layer P1 and the second visual effect produced by the second pattern layer P2.

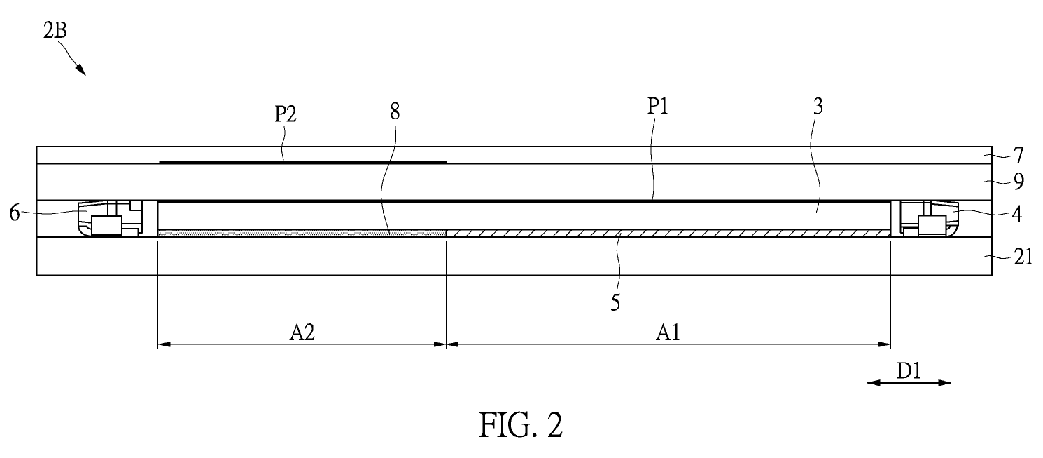

Reference is made to FIG. 2, which is a schematic cross-sectional view of an optical module 2B according to another embodiment of the present disclosure. Different from the embodiment shown in FIG. 1, in the optical module of FIG. 2, the second pattern layer P2 is formed on the light-transmissive layer 7. According to the embodiment shown in FIG. 2, the first light-emitting element 4 and the second light-emitting element 6 may emit light simultaneously or not simultaneously, or only the first light-emitting element 4 or the second light-emitting element 6 may be selectively turned on. Thus, regarding the first light-emitting element 4 and the first pattern layer P1, when the first light-emitting element 4 is turned on, a first visual effect, such as an infinity mirror effect, can be displayed. Regarding the second light-emitting element 6 and the second pattern layer P2, when the second light-emitting element 6 is turned on, a second visual effect, such as a normal display effect, can be displayed. The optical module 2B may further comprise a covering layer 8 disposed between the substrate 21 and the light guide plate 3, and corresponding to the second region A2, for covering circuits on the substrate 21. The covering layer 8 may be an opaque dark-colored ink layer serving as an anti-reflection layer, or a diffusion film layer configured to increase light intensity.

Reference is made to FIG. 3, which is a schematic cross-sectional view of an optical module 2C according to another embodiment of the present disclosure. In this embodiment, the reflective layer 5 is disposed under the light guide plate 3, and in addition to corresponding to the first region A1, also extends to correspond to the second region A2. Furthermore, in the embodiment shown in FIG. 3, the optical module 2C further comprises a covering layer 8 disposed between the reflective layer 5 and the light guide plate 3 and corresponding to the second region A2. The covering layer 8 may be formed of dark-colored or black ink. The covering layer 8 may also be an opaque film layer made of black material. The second pattern layer P2 is formed on a surface of the light guide plate 3 opposite to the covering layer 8. More specifically, the covering layer 8 may be used to cover the reflective layer 5 opposite to the second pattern layer P2. In this way, when both the first light-emitting element 4 and the second light-emitting element 6 emit light simultaneously, light emitted from the second light-emitting element 6 will not be repeatedly reflected inside the light guide plate 3, but will directly provide the second visual effect of the second pattern layer P2. Thus, the light emission effect of the second pattern layer P2 will not affect the first visual effect presented by the first pattern layer P1.

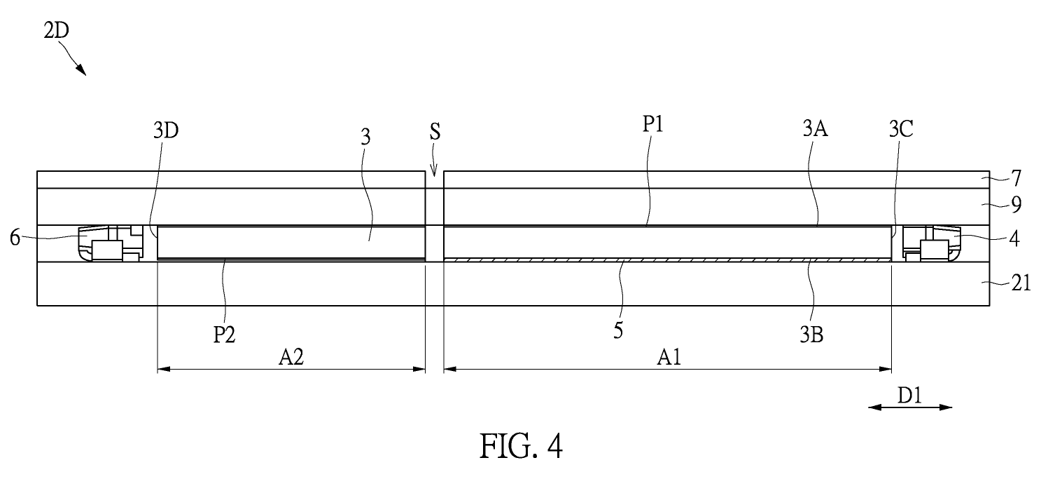

Reference is made to FIG. 4, which is a schematic cross-sectional view of an optical module 2D according to another embodiment of the present disclosure. In this embodiment, the optical module 2D further comprises a barrier layer S formed between the first side portion 3C and the second side portion 3D. The barrier layer S separates the light-transmissive layer 7 from the light guide plate 3 and divides the first region A1 and the second region A2. The first pattern layer P1 and the second pattern layer P2 are paired with their respective light sources (the first light-emitting element 4 and the second light-emitting element 6), and the visual effects of the first pattern layer P1 and the second pattern layer P2 can be displayed separately or simultaneously. By providing the barrier layer S, the visual effects of the first pattern layer P1 and the second pattern layer P2 do not affect or interfere with each other, thereby achieving clean, independent, and clear visual effects. In some embodiments, the barrier layer S is made of a non-transmissive material. In other embodiments, the barrier layer S may be an air layer, i.e., a separation formed of air.

Reference is made to FIG. 5, which is a schematic partial top view of an optical module according to one embodiment of the present disclosure. In this embodiment, the first light-emitting element 4 includes a plurality of light-emitting elements arranged at intervals along a second direction D2, with a first interval G1 defined between two adjacent first light-emitting elements 4. The second light-emitting element 6 includes a plurality of light-emitting elements arranged at intervals along the second direction D2, with a second interval G2 defined between two adjacent second light-emitting elements 6. The second direction D2 may be orthogonal to the first direction D1, but the present disclosure is not limited thereto. For example, in other embodiments, as long as the first visual effect of the first pattern layer P1 and the second visual effect of the second pattern layer P2 do not interfere with each other, the plurality of first light-emitting elements 4 may be arranged at intervals along the second direction D2, while the plurality of second light-emitting elements 6 may be arranged at intervals along the first direction D1, without requiring opposite configuration. Furthermore, in some embodiments, the first light-emitting element 4 and the second light-emitting element 6 may have the same or different emission wavelength ranges.

Reference is further made to FIGS. 1 and 5. In the embodiment shown in FIG. 1, the optical module further comprises the supporting frame 9 and a light-transmissive cover 10. The supporting frame 9 is disposed between the light-transmissive layer 7 and the light guide plate 3, and is of a hollow structure. The light-transmissive cover 10 is disposed on the light-transmissive layer 7 and is tightly bonded thereto. The supporting frame 9 defines a display window W, through which the first pattern layer P1 and the second pattern layer P2 can present the first and second visual effects.

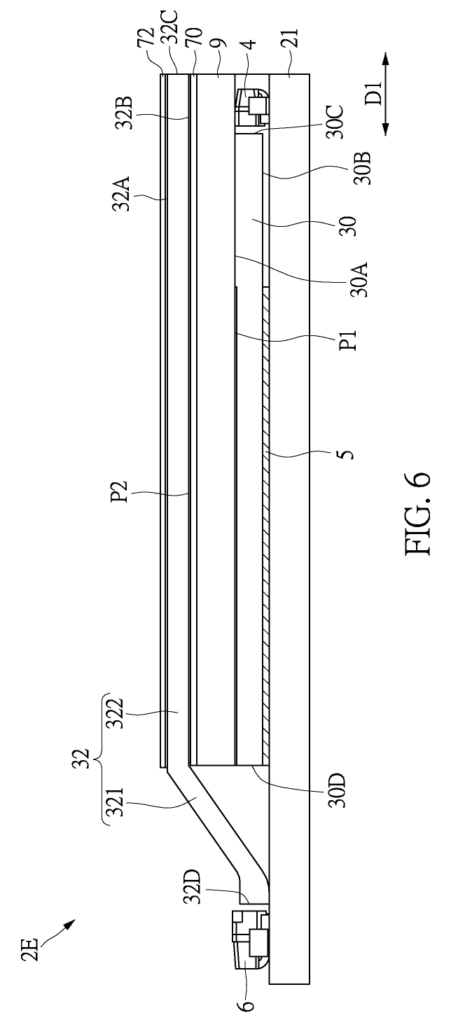

Reference is made to FIG. 6, which is a schematic cross-sectional view of an optical module 2E according to another embodiment of the present disclosure. The optical module 2E includes: a substrate 21, a reflective layer 5, a first light guide plate 30, a first pattern layer P1, a first light-emitting element 4, a supporting frame 9, a first light-transmissive layer 70, a second light-emitting element 6, a second light guide plate 32, a second pattern layer P2, and a second light-transmissive layer 72. The reflective layer 5 is disposed on the substrate 21. The first light guide plate 30 is disposed on the reflective layer 5. The first light guide plate 30 has a first surface 30A and a second surface 30B opposite to the first surface 30A, the second surface 30B facing the substrate 21. The first light guide plate 30 extends in the first direction D1 and has a first side portion 30C and a second side portion 30D opposite to the first side portion 30C. The first pattern layer P1 is formed on the first surface 30A or the second surface 30B of the first light guide plate 30. The first light-emitting element 4 is disposed on the substrate 21 and emits light toward the first side portion 30C of the first light guide plate 30. The supporting frame 9 is disposed above the first light guide plate 30. The first light-transmissive layer 70 is disposed on the supporting frame 9 and away from the substrate 21. The second light-emitting element 6 is disposed on the substrate 21. The second light guide plate 32 is disposed on the first light-transmissive layer 70 and has a third surface 32A and a fourth surface 32B opposite to the third surface 32A, the fourth surface 32B facing the substrate 21. The second light guide plate 32 extends in the first direction D1 and has a third side portion 32C and a fourth side portion 32D opposite to the third side portion 32C, wherein the fourth side portion 32D is adjacent to the light-emitting surface of the second light-emitting element 6. The light-emitting surfaces of the first light-emitting element 4 and the second light-emitting element 6 may be opposite to each other and located on the same horizontal plane, or may be positioned on different horizontal planes, and the present disclosure is not limited thereto. In this embodiment, as an example, the light-emitting surfaces of the first light-emitting element 4 and the second light-emitting element 6 are opposite to each other and located on the same horizontal plane of the substrate 21. Since the second light guide plate 32 is stacked on the first light-transmissive layer 70, the second light guide plate 32 is flexible so that the fourth side portion 32D can extend to face the light-emitting surface of the second light-emitting element 6. Furthermore, the second light guide plate 32 includes a bent portion 321 and an extension portion 322. One end of the bent portion 321 is connected to the extension portion 322, and the other end of the bent portion 321 is adjacent to the light-emitting surface of the second light-emitting element 6. The extension portion 322 of the second light guide plate 32 covers the first light-transmissive layer 70. The second light-transmissive layer 72 covers the extension portion 322. The second pattern layer P2 is formed on either the third surface 32A or the fourth surface 32B of the second light guide plate 32. The orthogonal projections of the first pattern layer P1 and the second pattern layer P2 onto the substrate 21 are non-overlapping or partially overlapping. The first light-emitting element 4 and the second light-emitting element 6 can be controlled independently to selectively turn on or off. According to the embodiment shown in FIG. 6, the first visual effect (e.g., infinity mirror effect) presented by the first pattern layer P1 and the second visual effect (e.g., normal display effect) presented by the second pattern layer P2 may be displayed simultaneously or individually.

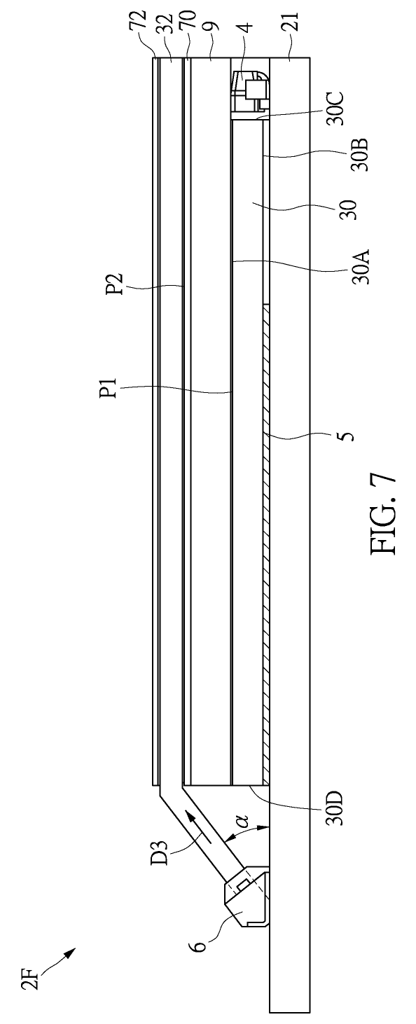

Reference is made to FIG. 7, which is a schematic cross-sectional view of an optical module 2F according to another embodiment of the present disclosure. The difference between the embodiments shown in FIGS. 6 and 7 lies in that the light-emitting direction D3 of the second light-emitting element 6 is orthogonal to its light-emitting surface and forms an included angle α with the surface of the substrate 21. To meet diverse requirements, a user may consider factors such as the height of the second pattern layer P2 and the flexibility of the second light guide plate 32, and may preset the included angle α between the light-emitting direction D3 of the second light-emitting element 6 and the surface of the substrate 21 according to customer needs.

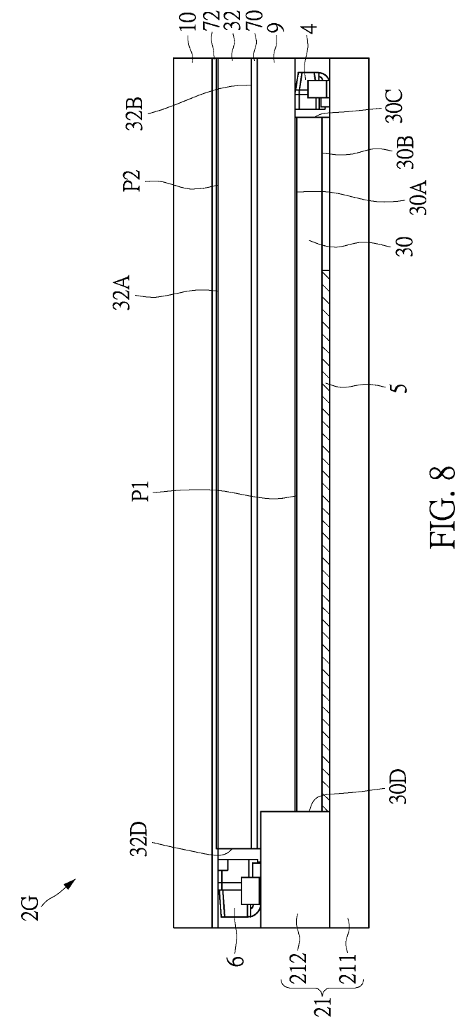

Reference is made to FIG. 8, which is a schematic cross-sectional view of an optical module 2G according to another embodiment of the present disclosure. In this embodiment, the substrate 21 includes a main body part 211 and an extension part 212. The extension part 212 is disposed on the main body part 211 and is adjacent to the second side portion 30D of the first light guide plate 30. The second light-emitting element 6 is disposed on the extension part 212 and emits light toward the fourth side portion 32D of the second light guide plate 32. The reflective layer 5 is disposed on the main body part 211 and between the first light guide plate 30 and the main body part 211. The second surface 30B of the first light guide plate 30 faces the main body part 211. The first light-emitting element 4 is disposed on the main body part 211 and emits light toward the first side portion 30C of the first light guide plate 30. The fourth surface 32B of the second light guide plate 32 faces the main body part 211. The difference between the embodiments shown in FIGS. 6 and 8 lies in that the first light-emitting element 4 and the second light-emitting element 6 are positioned on different horizontal planes of the substrate 21. According to the embodiment shown in FIG. 8, the second light-emitting element 6 is disposed on the extension part 212, so that in the vertical direction, the height at which the second light-emitting element 6 is located is higher than that of the first light-emitting element 4. The main body part 211 and the extension part 212 may be formed by stacking unit circuit boards (i.e., multilayer circuit boards).

Reference is further made to FIG. 8. In this embodiment, the optical module 2G further comprises a light-transmissive cover 10. The light-transmissive cover 10 is disposed on and is tightly bonded to the second light-transmissive layer 72.

In some embodiments, with reference again to FIG. 5 and taking the optical module 2E as an example, the first light-emitting element 4 may include a plurality of elements, and the second light-emitting element 6 may also include a plurality of elements. The plurality of first light-emitting elements 4 and the plurality of second light-emitting elements 6 may be arranged at intervals along the second direction D2, with a first interval G1 defined between two adjacent first light-emitting elements 4 and a second interval G2 is defined between two adjacent second light-emitting elements 6. The plurality of first light-emitting elements 4 and the plurality of second light-emitting elements 6 can further enhance the optical performance (visual effect) of the optical module.

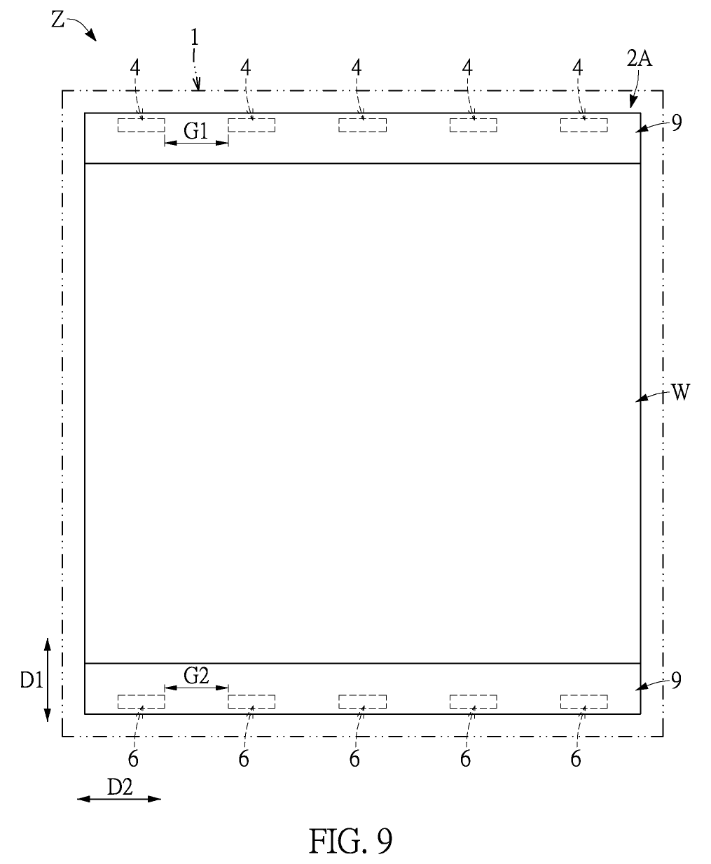

Reference is made to FIG. 9, which is a schematic top perspective view of an electronic device Z according to one embodiment of the present disclosure. The electronic device Z includes a housing 1 and the optical module 2A, wherein the optical module 2A disposed within the housing 1. The housing 1 may be a frame or a casing. The electronic device Z can be applied to art installations, billboards, signage, and electronic products such as notebook computers or computer cases. In the embodiment shown in FIG. 9, the electronic device Z is a notebook computer.

One of the technical advantages of the present disclosure is that, by virtue of “the first pattern layer corresponding to the first region being formed on any surface of the light guide plate,” “the second pattern layer corresponding to the second region being formed on any surface of the light guide plate or on a surface of the light-transmissive layer,” and “the first light-emitting element and the second light-emitting element being controlled to selectively turn on or off,” the optical module provided by the present disclosure is capable of improving visual effects. The first visual effect presented by the first pattern layer differs from the second visual effect presented by the second pattern layer. For example, the first visual effect presented by the first pattern layer is an infinity mirror effect, while the second visual effect presented by the second pattern layer is a normal display effect. The visual effects of the first pattern layer and the second pattern layer can be displayed simultaneously or individually.

Another technical advantage of the present disclosure is that, by incorporating the optical module into an electronic device, the electronic device can provide both the first visual effect and the second visual effect, which may be selectively displayed simultaneously or individually. Accordingly, the housing component of the electronic device can offer greater diversity in terms of color or pattern presentation.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An optical module, comprising:
a substrate;
a light guide plate disposed above the substrate, the light guide plate having a first surface and a second surface opposite to the first surface, the second surface facing the substrate, the light guide plate extending in a first direction and having a first side portion and a second side portion opposite to the first side portion, wherein the second surface is divided into at least two regions, one of the regions of the second surface adjacent to the first side portion being defined as a first region, and another region of the second surface adjacent to the second side portion being defined as a second region;
at least one first light-emitting element disposed on the substrate and configured to emit light toward the first side portion of the light guide plate;
a reflective layer disposed between the substrate and the light guide plate and corresponding to the first region;
at least one second light-emitting element disposed on the substrate opposite to the at least one first light-emitting element and configured to emit light toward the second side portion of the light guide plate;
a light-transmissive layer disposed above the light guide plate and away from the substrate;
a first pattern layer corresponding to the first region and formed on any surface of the light guide plate; and
a second pattern layer corresponding to the second region and formed on any surface of the light guide plate, or on a surface of the light-transmissive layer;
wherein the at least one first light-emitting element and the at least one second light-emitting element are controllable to be selectively turned on or off.

2. The optical module according to claim 1, wherein the reflective layer further extends along the first direction and corresponds to the second region.

3. The optical module according to claim 2, further comprising a covering layer corresponding to the second region and disposed between the reflective layer and the light guide plate.

4. The optical module according to claim 1, further comprising a covering layer corresponding to the second region and disposed between the substrate and the light guide plate.

5. The optical module according to claim 1, further comprising a barrier layer formed between the first side portion and the second side portion, the barrier being configured to separate the light-transmissive layer from the light guide plate and to divide the first region and the second region.

6. The optical module according to claim 5, wherein the barrier layer is made of an opaque material.

7. The optical module according to claim 5, wherein the barrier layer is an air layer.

8. The optical module according to claim 1, wherein the at least one first light-emitting element comprises a plurality of first light-emitting elements arranged at intervals along a second direction, with a first interval defined between two adjacent first light-emitting elements; and the at least one second light-emitting element comprises a plurality of second light-emitting elements arranged at intervals along the second direction, with a second interval defined between two adjacent second light-emitting elements.

9. The optical module according to claim 1, wherein an orthogonal projection of the first pattern layer onto the substrate does not overlap or partially overlaps an orthogonal projection of the second pattern layer onto the substrate.

10. The optical module according to claim 1, further comprising:
a supporting frame disposed between the light-transmissive layer and the light guide plate; and
a light-transmissive cover disposed on and tightly bonded to the light-transmissive layer.

11. The optical module according to claim 1, wherein the light-transmissive layer is a semi-transmissive film, and a reflectance of the light-transmissive layer is greater than or equal to a transmittance of the light-transmissive layer.

12. The optical module according to claim 1, wherein the light-transmissive layer is a semi-transmissive film, or is formed by splicing a fully-transmissive film and the semi-transmissive film along the first direction.

13. The optical module according to claim 1, wherein the at least one first light-emitting element emits light to present a first visual effect through the first pattern layer, and the at least one second light-emitting element emits light to present a second visual effect through the second pattern layer, the first visual effect and the second visual effect being displayed simultaneously or individually.

14. The optical module according to claim 13, wherein the first visual effect is an infinity mirror effect, and the second visual effect is a normal display effect.

15. An optical module, comprising:
a substrate;
a reflective layer disposed on the substrate;
a first light guide plate disposed on the reflective layer, the first light guide plate having a first surface and a second surface opposite to the first surface, the second surface facing the substrate, the first light guide plate extending in a first direction and defining a first side portion and an opposite second side portion;
a first pattern layer formed on the first surface or the second surface of the first light guide plate;
at least one first light-emitting element disposed on the substrate and configured to emit light toward the first side portion of the first light guide plate;
a supporting frame disposed above the first light guide plate;
a first light-transmissive layer disposed on the supporting frame and away from the substrate;
at least one second light-emitting element disposed on the substrate;
a second light guide plate disposed on the first light-transmissive layer, the second light guide plate having a third surface and a fourth surface opposite to the third surface, the fourth surface facing the substrate, the second light guide plate extending in the first direction and defining a third side portion and an opposite fourth side portion, wherein the fourth side portion is adjacent to a light-emitting surface of the at least one second light-emitting element;
a second pattern layer formed on the third surface or the fourth surface of the second light guide plate; and
a second light-transmissive layer disposed on the second light guide plate;
wherein the at least one first light-emitting element and the at least one second light-emitting element are controllable to be selectively turned on or off.

16. The optical module according to claim 15, wherein the substrate includes a main body part and an extension part, the extension part being disposed on the main body part and adjacent to the second side portion of the first light guide plate;
wherein the at least one second light-emitting element is disposed on the extension part and configured to emit light toward the fourth side portion of the second light guide plate;
wherein the reflective layer is disposed on the main body part;
wherein the second surface of the first light guide plate faces the main body part;
wherein the at least one first light-emitting element is disposed on the main body part and configured to emit light toward the first side portion of the first light guide plate; and
wherein the fourth surface of the second light guide plate faces the main body part.

17. The optical module according to claim 15, wherein the second light guide plate is flexible and comprises a bent portion and an extension portion, the bent portion having one end connected to the extension portion and an opposite end adjacent to the light-emitting surface of the at least one second light-emitting element, the extension portion covering the first light-transmissive layer, and the second light-transmissive layer covering the extension portion.

18. The optical module according to claim 17, wherein the at least one second light-emitting element has a light-emitting direction orthogonal to the light-emitting surface and forms an included angle with a surface of the substrate.

19. The optical module according to claim 15, wherein the at least one first light-emitting element comprises a plurality of first light-emitting elements arranged at intervals along a second direction, with a first interval defined between two adjacent first light-emitting elements; and the at least one second light-emitting element comprises a plurality of second light-emitting elements arranged at intervals along the second direction, with a second interval defined between two adjacent second light-emitting elements.

20. The optical module according to claim 15, wherein an orthogonal projection of the first pattern layer onto the substrate does not overlap or partially overlaps an orthogonal projection of the second pattern layer onto the substrate.

21. The optical module according to claim 15, wherein the first light-transmissive layer is a semi-transmissive film, and a reflectance of the light-transmissive layer is greater than or equal to a transmittance of the light-transmissive layer.

22. The optical module according to claim 15, further comprising a light-transmissive cover disposed on and tightly bonded to the second light-transmissive layer.

23. The optical module according to claim 15, wherein the at least one first light-emitting element emits light to present a first visual effect through the first pattern layer, and the at least one second light-emitting element emits light to present a second visual effect through the second pattern layer, the first visual effect and the second visual effect being displayed simultaneously or individually.

24. The optical module according to claim 23, wherein the first visual effect is an infinity mirror effect, and the second visual effect is a normal display effect.

25. An electronic device, comprising:
a housing; and
the optical module as claimed in claim 1, disposed within the housing.

26. The electronic device according to claim 25, wherein the at least one first light-emitting element emits light to present a first visual effect through the first pattern layer, and the at least one second light-emitting element emits light to present a second visual effect through the second pattern layer, the first visual effect and the second visual effect being displayed simultaneously or individually.

27. The electronic device according to claim 26, wherein the first visual effect is an infinity mirror effect, and the second visual effect is a normal display effect.

28. An electronic device, comprising:
a housing; and
the optical module according to claim 15, disposed within the housing.

29. The electronic device according to claim 28, wherein the at least one first light-emitting element emits light to present a first visual effect through the first pattern layer, and the at least one second light-emitting element emits light to present a second visual effect through the second pattern layer, the first visual effect and the second visual effect being displayed simultaneously or individually.

30. The electronic device according to claim 29, wherein the first visual effect is an infinity mirror effect, and the second visual effect is a normal display effect.
